(19) United States
(12) Patent Application Publication
(10) Pub. No.: US 2015/0129712 A1
(43) Pub. Date: May 14, 2015

(54) METHOD FOR IMPROVING AIRPORT RAMP THROUGHPUT

(71) Applicants: Isaiah W. Cox, Baltimore, MD (US); Joseph Cox, North Plains, OR (US); Jan Vana, North Plains, OR (US); Joseph Goldman, North Plains, OR (US)

(72) Inventors: Isaiah W. Cox, Baltimore, MD (US); Joseph Cox, North Plains, OR (US); Jan Vana, North Plains, OR (US); Joseph Goldman, North Plains, OR (US)

(73) Assignee: BOREALIS TECHNICAL LIMITED, London (GB)

(21) Appl. No.: 13/526,483

(22) Filed: Jun. 18, 2012

Related U.S. Application Data
(60) Provisional application No. 61/498,190, filed on Jun. 17, 2011.

(51) Int. Cl. B64C 25/40; G08G 5/00

(52) U.S. Cl. CPC B64C 25/405; G08G 5/0021
USPC 244/50

(57) ABSTRACT

A method for improving airport and ramp throughput is provided. The method minimizes the time interval between an aircraft's landing and takeoff by independently moving the aircraft with an onboard electric driver that drives at least one of the aircraft's wheels on the ground without the aircraft's engines. Turnaround time and aircraft idle time are reduced by eliminating engine operation while the aircraft is moving in the ramp area. The time between when an aircraft is not moving between pushback and taxi forward is substantially eliminated, leading to more efficient ramp operations as ramp space is freed for through traffic.

### PRIORITY CLAIM

This application claims priority from U.S. Provisional Patent Application No. 61/498,190, filed Jun. 17, 2011, the disclosure of which is hereby incorporated by reference.

### TECHNICAL FIELD

The present invention relates generally to methods for improving airport ramp throughput and specifically to a method for improving airport ramp throughput by equipping aircraft with apparatus that enables the aircraft to move independently on the ground, thereby significantly reducing turnaround and idle time and improving ramp throughput.

### BACKGROUND OF THE INVENTION

The operation of airlines and airports today focuses on achieving maximum efficiency to keep operating costs as low as possible while continuing to provide travelers with a safe and economical mode of travel. Maximizing airport, especially ramp, throughput has received considerable focus recently as arrivals and departures at high density airports have increased. At such airports the demand for runway and ramp capacity is high, and surface movements of aircraft and other vehicles must be carefully coordinated. The maintenance of peak throughput performance requires, at a minimum, new procedures to enhance airport surface movements, reduce spacing and separation requirements, and improve overall traffic flow management.

It is desired to keep the time an aircraft spends idle on the ground at an airport between landing, arrival at and departure from the gate, and take-off to the minimum required to unload arriving passengers and cargo, service the aircraft, and load departing passengers and cargo. Minimizing ramp throughput time not only reduces delays in airline flight schedules, but also increases the possibility that an airline can schedule additional flights, providing travelers with more options and improving airline profits. Since increased aircraft ground traffic may be accompanied by an increased risk of ground incidents involving aircraft, ground vehicles, and even passengers and ground personnel, improving ramp throughput should not be at the expense of increased ground safety risks.

Increasing airport and, consequently ramp, throughput has received the attention of the Federal Aviation Administration (FAA), National Aeronautics and Space Administration (NASA), and others, and proposals to maximize throughput and improve airport efficiency have been presented. Benefits of these proposals include reductions in flight time, noise, and fuel burn, as well as in engine emissions. To date, the proposals to maximize and improvement airport throughput involve software based systems, such as the RampLogic system proposed by Lockheed Martin. This system uses a critical mass of data from various sources to manage ramp operation, employing an algorithm for sequencing and runway queuing. The Lockheed Martin system is stated to reduce taxi time, surface congestion and occupancy, and fuel emissions and to increase savings to airlines based on taxi-out time reduction. PASSUR Aerospace, Inc. provides web-based ramp management solutions in their Ramp Tower Management Program. U.S. Pat. No. 6,161,097, assigned to NASA, additionally discloses an automated traffic management system and method that can be used for scheduling the movement of aircraft to improve ramp operations. None of the aforementioned proposals or systems for improving airport or ramp throughput, however, suggests that aircraft could be modified in any way to effect the improvements in airport or ramp throughput attributed to their use.

It is uniformly acknowledged that minimizing the time an aircraft spends sitting idle on the ground between taxi-in after landing and taxi-out prior to takeoff maximizes airline and airport savings. At many airports, space is constrained. Aircraft that are being pushed back block the ramp area and taxiways, delaying the movement of incoming aircraft into the gate and blocking the transit of ground vehicles. Delays in the ramp area can also be costly. Since airlines typically own a series of gates, they have a particular interest in improving ramp throughput to move aircraft quickly to clear gates and free taxiways so surface traffic flows smoothly.

The traffic management system described in U.S. Pat. No. 6,161,097, for example, was stated to reduce the departure taxi time by about one minute per aircraft at the Atlanta airport. With direct costs of $40 per minute, overall annual cost savings of about $12 to $15 million could be achieved. It has been estimated that by reducing taxi-out time by one, two, or three minutes, using fuel and maintenance alone to calculate savings, a generic major airline with three major hubs could realize annual savings of $5, $10, or $15 million, respectively.

It is desirable to reduce not only the taxi-out time, but the total time required for an aircraft to turn around completely between landing and takeoff to improve ramp throughput. A system and method for reducing turnaround time of an aircraft is described in U.S. Patent Application Publication No. US 2008/0059053 to Cox et al, owned in common with the present application. The system and method described therein suggests that aircraft turbines may be turned on only when needed for takeoff or prior to landing and are turned off until takeoff or after landing. The aircraft is moved along taxiways using at least one self propelled undercarriage wheel. This method focuses on reducing turnaround times by having all of the required equipment available for turnaround and departure and minimizing the use of motorized tugs while providing an enhanced communication system between the pilot and ground personnel. A method for improving airport or ramp throughput is not specifically suggested, however.

McCoskey et al also describes a powered nose aircraft wheel system useful in a method of taxiing an aircraft that can minimize the assistance needed from tugs and the aircraft engines. A precision guidance system including ground elements that interact with aircraft elements is disclosed for controlling movement of the aircraft on the ground during taxi. A method for improving airport or ramp throughput is not suggested, however.

The prior art has not appreciated the connection between structurally modifying an aircraft to efficiently move the aircraft on the ground between landing and takeoff and improving airport and ramp throughput. A need exists, therefore, for a method for improving airport and ramp throughput that relies primarily on an aircraft's ability to be driven on the ground independently of engines or ground vehicles to reduce significantly the amount of time the aircraft is idle.

### SUMMARY OF THE INVENTION

It is a primary object of the present invention, therefore, to provide a method for improving airport and ramp throughput that relies primarily on an aircraft's ability to be driven on the ground independently of engines or ground vehicles, thereby reducing significantly aircraft idle time.

It is another object of the present invention to provide a method for improving airport and ramp throughput and simultaneously reducing aircraft turnaround times by providing a method for safely moving an aircraft on the ground in the ramp area without assistance from the aircraft's engines.

It is an additional object of the present invention to provide a method for improving airport and ramp throughput by eliminating the need for and, thus, the time required to attach and/or detach external tug or tow vehicles to an aircraft.

It is a further object of the present invention to provide a method for improving airport and ramp throughput that reduces the time required for pushback.

It is yet another object of the present invention to provide a method for improving airport and ramp throughput that minimizes surface congestion and occupancy and enhances traffic flow.

It is yet an additional object of the present invention to provide a method for increasing airport and ramp throughput that can produce significant cost savings to airlines and airports.

It is yet a further object of the present invention to provide a method for improving airport and ramp throughput that reduces aircraft fuel usage and emissions.

It is a still further object of the present invention to provide a method for improving airport and ramp throughput that eliminates the time previously required for tug disconnect, hydraulic steering pin removal, engine start while the aircraft is not moving, completing initial start checklists, and clearing ground crew prior to moving the aircraft forward.

It is a still further object of the present invention to provide a method for improving airport and ramp throughput that combines automated and web-based ramp operation methods with a method for driving an aircraft on the ground independently of the aircraft's engines or external tow vehicles.

In accordance with the aforesaid objects, a method for improving airport and ramp throughput that relies primarily on an aircraft's ability to be driven on the ground independently of engines or ground vehicles after landing and prior to takeoff is provided. The present method equips an aircraft with an onboard electric drive means powering at least one aircraft drive wheel with power from a source that does not require the operation of any of the aircraft's main engines. Movement of the aircraft on the ground is controlled solely by the operation of this electric driver-powered drive wheel in conjunction with the aircraft flight crew or, alternatively, remotely to move the aircraft efficiently to and from runways and taxiways and through the ramp area. Even more significant improvements in ramp throughput and reductions in aircraft turnaround time can be achieved by expanding the present method to include an automated or web-based airport or ramp traffic management system.

Ramp safety is improved as the aircraft's ground movement does not require operating jet engines, thereby eliminating the hazards that accompany jet blast and the potential for engine ingestion. Moreover, passengers can safely disembark and cargo can be removed from the aircraft as soon as the aircraft stops, significantly reducing turnaround time. Ramp safety is further improved by the elimination of tug or tow tractors, which significantly reduces the number of ground vehicles in the ramp area. The time formerly required to attach and then detach a tow vehicle or to wait for the aircraft engines to be turned off prior to carrying out arrival procedures is also eliminated.

Other objects and advantages will be apparent from the following description, claims, and drawing.

### BRIEF DESCRIPTION OF THE DRAWINGS

FIG. 1 illustrates an airport ramp area with an aircraft entering the gate area; and

FIG. 2 shows a top view of airport ramp and taxiway areas with multiple aircraft in the ramp areas.

### DETAILED DESCRIPTION OF THE INVENTION

Air traffic has been increasing both nationally and internationally, and this growth is expected to continue into the foreseeable future. Increased traffic raises questions regarding airport capacity, surface safety, traffic planning, and surface flow efficiency. Most airports in the United States have limited ability to expand to meet expected needs for increased capacity. As a result, added capacity must be achieved through more efficient and safe use of existing airport facilities. Additional challenges to airline and airport operators struggling to meet the demands of increased air traffic and keep operating costs reasonable are posed by the increased costs of fuel and the increased costs associated with inefficient ramp and airport throughput.

Suggestions have been made to reduce the time required for an aircraft to land, taxi to a gate or parking location adjacent to an air terminal, unload arriving passengers and/or cargo, service the aircraft, load departing passengers and/or cargo, pushback from the gate or parking location, taxi to a runway, and take off. Minimizing this turnaround time has, in addition to improving airport and ramp throughput, many advantages for an airline. Unfortunately, moving an aircraft from landing to takeoff as quickly as possible has the potential to compromise ramp safety. Achieving and maintaining a safe ramp environment where the likelihood of damage or injury caused by aircraft engines to ground vehicles or other aircraft or to people is substantially eliminated and ramp throughput and turnaround time are simultaneously improved is possible with the method of the present invention.

The present method is able to minimize the total time required to move an aircraft from an initial taxi point on a runway after landing to arrival at a parking location in the ramp area. Arriving passengers and/or cargo are unloaded and the aircraft serviced, departing passengers and/or cargo are loaded, the aircraft is moved away from the parking location and taxis to a departure point for takeoff independently without assistance from the aircraft engines or from either tugs or tow vehicles. Because the aircraft engines are not required to be operational during this time, the jet blast hazard is eliminated. There is, in addition, no likelihood of engine ingestion when the engines are not operating. Moreover, because engine noise is also eliminated, communication among ground personnel is improved. The time previously required to locate and attach a tug upon arrival to move the aircraft into the ramp area to the parking location and then detach the tug is not needed. The additional time required to locate and attach a tug for pushback, maneuver the aircraft with the tug to push it back from the parking location, and then detach the tug after pushback does not have to be factored into the turnaround time. The cockpit crew controls the ground movement of the aircraft and can operate the aircraft in conjunction with ground crew more safely during turnaround without having to worry about the logistics of dealing with tugs or operating engines producing jet blast hazards.

Rapid turnaround is possible with the present method. Taxi time can be reduced by at least two minutes, which means that the aircraft is not blocking the taxiway and more aircraft and other vehicles can travel in the same area. The pushback process for an aircraft not equipped with a powered drive wheel in accordance with the method of the present invention can take a period of time ranging from about 70 to 200 seconds. During this time, the tug must be disconnected, safety checks must be started, the aircraft engines must be started, the ground crews waved off, and all other procedures are completed. The aircraft is standing still during these procedures, wasting both time and money. Moreover, as these procedures are being conducted, the aircraft is blocking the taxiway so that other aircraft and ground vehicles must wait until the aircraft is cleared to move out of the way. With the method of the present invention, an aircraft can push back and move forward without delay, minimizing space blockage, freeing taxiways and improving ground traffic flow. The aircraft is not required to be at a stop when the engines are started. Time savings are achieved in accordance with the present method because the aircraft can be on the runway and taxiing toward takeoff before the cockpit crew must start the engines. Additionally, the aircraft's engines can be shut off a very short time interval after the aircraft has landed, which further reduces turnaround time and improves ramp throughput.

An aircraft useful in the method of the present invention is equipped with at least one drive wheel powered by a controllable onboard electric drive motor capable of moving the aircraft independently as required on the ground between landing and takeoff. An electric drive motor preferred in the present method will be mounted in driving relationship with one or more of the aircraft wheels to move the wheels at a desired speed and torque. Electric drive motors useful for this purpose may be selected from those known in the art. One drive motor preferred for this purpose is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. Any form of electric motor capable of driving an aircraft on the ground, including but not limited to electric induction motors, permanent magnet brushless DC motors, switched reluctance motors, hydraulic pump/motor assemblies, and pneumatic motors may also be used. Other motor designs capable of high torque operation across the speed range that can be integrated into an aircraft drive wheel to function as described herein may also be suitable for use in reducing turnaround time and improving ramp throughput according to the method of the present invention.

The pilot or flight crew directs the ground movement of the aircraft between the runway and the ramp. Power for the onboard electric drive motor does not require operation of the aircraft engines to move the aircraft either into or out of the ramp area, thereby effectively eliminating the hazards associated with both jet blast and engine ingestion. The aircraft's engines are known to be off when the aircraft moves through the ramp. Consequently, the aircraft can be serviced more rapidly because ground vehicles can move in faster upon arrival of the aircraft. Passengers can leave (or board) the aircraft by stairways more quickly and safely. The ability to allow passengers to leave an aircraft by the stairs as soon as an aircraft arrives can produce substantial time savings. Noise in the ramp area is greatly reduced because the aircraft's engines are not operating, and ramp safety is vastly improved because the risks of engine ingestion and jet blast are eliminated. Additionally, neither tugs nor tow vehicles are required to move the aircraft into or out of the ramp area, which can significantly reduce the number of ground vehicles moving around the ramp, as well as the aircraft's idle time.

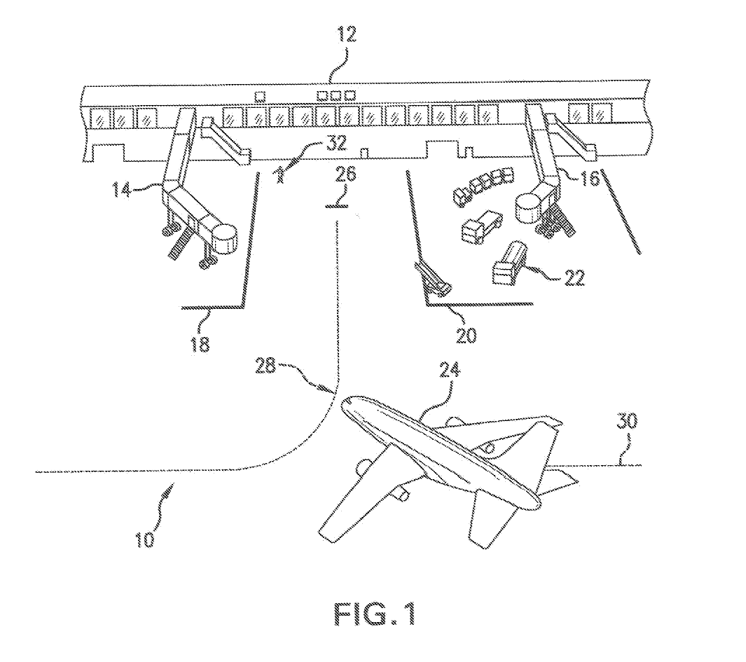

FIG. 1 illustrates a typical airport ramp operations area 10 outside an airport terminal 12 with adjacent jetways or air bridges 14, 16. Foul lines 18, 20 may define the boundaries of the ramp area that should not be crossed by unauthorized ground personnel or ground equipment and vehicles, designated by 22, until the aircraft 24 is parked at a stop location 26. The aircraft 24 is shown in a taxi location after landing just outside the ramp gate entry/exit area 28 taxiing along a path 30, guided to the stop location 26 by a ground controller 32. Upon departure, the aircraft 26 must move in reverse from the stop location 26 to the gate entry/exit location 28, and then to a point beyond the ramp area (not shown) where the aircraft can turn and begin to taxi in a forward direction to a runway for takeoff.

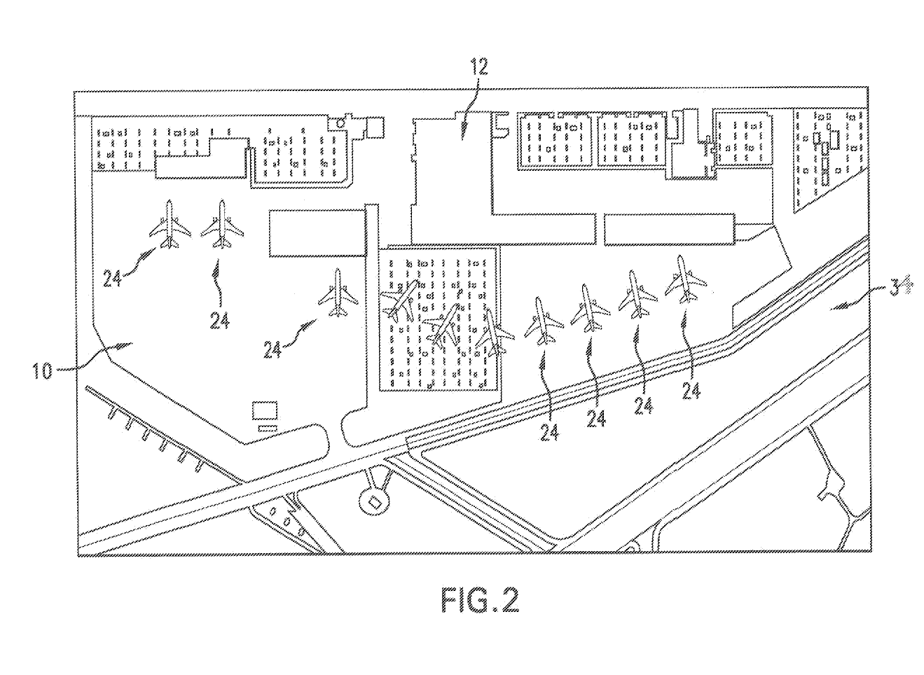

FIG. 2 shows an airport ramp area 10, terminal 12, and taxiway 32. Several aircraft 24 are shown parked in the ramp area. No ground vehicles are shown. The space constraints of this ramp, which are not as great as at many airports, and the close spacing of the aircraft can be clearly seen in FIG. 2. In this type of ramp area, passenger loading and unloading would most likely be by way of the aircraft stairs. Coordinating the departure and arrival procedures and the ground movement for this number of aircraft, even with the addition of necessary ground vehicles like baggage carriers and catering trucks, is greatly simplified with the method of the present invention. Each aircraft 24 is moved independently into and out of the ramp area with its powered drive wheel assembly in significantly less time than has heretofore been possible.

The present method of improving ramp throughput can also prevent the types of adverse ramp incidents that can occur upon entry into or exit from the gate (area 28) and in the gate stop area between area 28 and stop location 26 when an aircraft's engines are running. Engine ingestion is more likely to occur when an aircraft is parked with the engines running, even at idle speeds. Other types of ramp incidents have involved improperly attached or operated tugs. An aircraft equipped with an onboard electric drive motor that moves the aircraft independently on the ground into and out of the ramp area while the aircraft's engines are not operating will not cause engine ingestion or produce jet blast. The area around the aircraft's engines where engine ingestion is likely to occur will no longer be an off-limits hazard area. Since the present method does not use tugs and tow vehicles to move aircraft, damage associated with tug attachment, detachment, or operation will not occur. Substantially eliminating the causes for ramp incidents will result in substantial improvements to ramp safety as well as ramp throughput.

There are many airports throughout the world that do not have the jetways or air bridges 14 and 16 shown in FIG. 1 to connect the interior of the aircraft with the interior of the airport terminal. At these airports, such as the airport shown in FIG. 2, passengers and crew departing or boarding an aircraft must go outside the terminal and walk through the ramp area. Passengers and crew must also use stairs located at the forward or rear doors to board the aircraft. In the past, aircraft crew could not open the doors or lower the stairs upon arrival until the aircraft engines were turned off without risking damage to the stairs or injury to passengers or crew. This waiting time contributes to the overall time required for turnaround. At some airports, passengers are permitted to leave and board the aircraft from both forward and rear exits and stairs, which can shorten departure and boarding times. Until the present invention, however, the time saving benefits of using both exits could not be fully realized until the aircraft engines were completely shut off. Now, as soon as the aircraft comes to a full stop, both exits can be opened, the stairs can be lowered, and passengers can immediately leave or board the aircraft using both access locations, which takes much less time than using only a single exit to unload an aircraft, especially an aircraft with a large passenger capacity.

Aircraft servicing between arrival and departure can be performed more quickly than in the past. Service personnel can focus more quickly and efficiently on what needs to be checked and serviced during the turnaround time period to ready the aircraft for departure instead of being worried about getting too close to an engine inlet hazard zone and sucked into the engine nacelle or avoiding an aircraft's jet blast.

The improvements in airport and ramp throughput possible with the method of the present invention can be greatly enhanced by combining this method with available automated and/or web-based software and processes for managing airport traffic flow and surface and ramp performance. The potential time savings and increased throughput efficiency possible with such a combination are very significant. The savings in fuel usage and reduction in engine emissions with such as arrangement could also be substantial.

The method for improving airport and ramp throughput described herein has been described with respect to preferred embodiments. Other, equivalent, processes and structures are also contemplated to be within the scope of the present invention.

### INDUSTRIAL APPLICABILITY

The method of the present invention will find its primary applicability for use by airlines and airports when it is desired to improve airport and ramp throughput by minimizing the amount of time required between landing and takeoff of an aircraft and efficiently managing surface traffic flow to produce significant savings in operating and fuel costs and reductions in aircraft engine emissions.

1. A method for improving airport and ramp throughput by eliminating aircraft engine operation and driving the aircraft independently on the ground in an airport ramp area.

2. The method described in claim 1, wherein aircraft idle time between landing and takeoff is minimized.

3. The method described in claim 1, wherein aircraft turnaround time is minimized.

4. The method described in claim 1, wherein aircraft idle time during push back is reduced by a time period in the range of about 70 to 200 seconds.

5. The method described in claim 4, wherein said reduced time period is achieved by eliminating the requirement for performing pushback procedures in the ramp area while the aircraft is stopped.

6. The method described in claim 1, wherein the aircraft is driven independently on the ground by a controllable onboard electric driver drivingly mounted on at least one of the aircraft's wheels and powered by a power source other than the aircraft main engines.

7. The method described in claim 6, wherein the controllable onboard electric driver is selected from the group consisting of electric induction motors, permanent magnet brushless DC motors, switched reluctance motors, hydraulic pump/motor assemblies, and pneumatic motors.

8. A method for improving ramp throughput by reducing the time interval between an aircraft's arrival at and departure from an airport parking location in an airport ramp area.

9. The method described in claim 8, wherein the time interval required for pushback at departure is reduced by a time period within the range of about 70 to 200 seconds.

10. The method described in claim 9, wherein said reduced time period is achieved by eliminating the requirement for performing pushback procedures in the ramp area while the aircraft is stopped.

11. The method described in claim 8, wherein said aircraft is driven independently on the ground between arrival and departure without operation of the aircraft engines.

12. The method described in claim 11, wherein said aircraft is driven independently on the ground by a controllable onboard electric driver selected from the group consisting of electric induction motors, permanent magnet brushless DC motors, switched reluctance motors, hydraulic pump/motor assemblies, and pneumatic motors.

13. The method described in claim 8, wherein the reduced time interval moves aircraft efficiently through the ramp area, thereby increasing through traffic in the ramp area.

14. The method described in claim 1, further including when the aircraft is stopped at a designated gate parking location, immediately opening all available exit doors and lowering exit stairs at each exit door, thereby reducing the time required to unload passengers from the aircraft.

15. A method for simultaneously improving ramp throughput and minimizing the time interval between landing and takeoff of an aircraft equipped with a controllable onboard electric driver drivingly mounted to drive at least one aircraft wheel independently of the aircraft engines and external tow vehicles, wherein said method comprises completely shutting off the aircraft engines; activating and controlling said onboard electric driver to move the aircraft on the ground into a ramp area with a designated parking location adjacent to an airport terminal; inactivating the electric driver to stop the aircraft when said designated parking location is reached; immediately thereafter unloading arriving passengers or cargo; servicing the aircraft as required without the possibility of engine ingestion; loading departing passengers or cargo; and activating and controlling the onboard electric driver to move the aircraft in reverse to exit the gate area and the ramp, wherein the aircraft engines are started for takeoff.

16. The method described in claim 15, wherein the aircraft is moved on the ground by the onboard electric driver at all times and the aircraft engines are completely shut down while the aircraft is driven by the onboard electric driver in the ramp area and the gate.

17. The method described in claim 16, wherein the onboard electric driver is activated and controlled from the aircraft cockpit by at least one member of a flight crew.

18. The method described in claim 15, further including the steps of when the aircraft is stopped at the designated gate parking location immediately opening all available exit doors and lowering exit stairs at each exit door, thereby reducing the time required to unload passengers from the aircraft.

19. The method described in claim 15, wherein the time required between pushback and taxi forward prior to takeoff is reduced to a time interval within the range of 70 to 200 seconds.

20. The method described in claim 15, wherein the aircraft engines are turned on or shut off while the aircraft is moving on the ground.

21. A method for improving ramp throughput by maximizing the use of all available aircraft access doors and stair ramps for unloading passengers and cargo as soon as an aircraft has come to a complete stop on the ground upon arrival at an airport gate or parking location.

22. A method for improving ramp throughput by eliminating the time required for a tow vehicle to be first attached to and then detached from an aircraft to move the aircraft into or out of an airport parking location and by reducing the number of moving ground vehicles in the vicinity of the aircraft, thereby saving time and decreasing the likelihood of ramp incidents.

23. A method for improving airport and ramp throughput that minimizes the time interval between landing and takeoff of at least one of a plurality of aircraft, each of said aircraft being equipped with a controllable onboard electric driver drivingly mounted to drive at least one aircraft wheel independently of the aircraft engines and external tow vehicles to move said aircraft on the ground, including providing automated or web-based traffic management means for directing movement of said at least one and said plurality of aircraft in a manner that further minimizes the time interval between landing and takeoff.

24. The method described in claim 23, wherein said method reduces the time interval required for pushback prior to takeoff to a time interval less than about 70 to 200 seconds.

25. The method described in claim 24, wherein said reduced time interval is achieved by eliminating the requirement for performing pushback procedures in the ramp area while the aircraft is stopped.
